(19) United States
(12) Patent Application Publication
(10) Pub. No.: US 2007/0136809 A1
(43) Pub. Date: Jun. 14, 2007

(54) Apparatus and method for blocking attack against Web application

(76) Inventors: Hwan Kuk Kim, Seoul (KR); Myung Eun Kim, Daejeon-city (KR); Dong Il Seo, Daejeon-city (KR)

Correspondence Address: LADAS & PARRY LLP, 224 SOUTH MICHIGAN AVENUE, SUITE 1600, CHICAGO, IL, 60604, US

(21) Appl. No.: 11/634,736

(22) Filed: Dec. 6, 2006

(30) Foreign Application Priority Data
Dec. 8, 2005 (KR) 10-2005-0120092
Jun. 4, 2006 (KR) 10-2006-0031486

(51) Int. Cl. G06F 15/16; G06F 12/14; G06F 11/00; G06F 17/00; G06F 9/00; G06F 12/16; G06F 15/18; G08B 23/00

(52) U.S. Cl. 726/22; 726/13; 726/23; 726/25

(57) ABSTRACT

An apparatus and method for blocking an attack against a Web application are provided. The apparatus includes: an input value authentication unit authenticating an input value included in Web service request data and determining the attack; an input value filtering unit editing Web service request data determined as the attack by removing an attack element from the Web service request data; and a data transfer unit transferring Web service request data which is not determined as the attack and the edited Web service request data to a Web server.

### CROSS-REFERENCE TO RELATED PATENT APPLICATIONS

This application claims the benefit of Korean Patent Application Nos. 10-2005-0120092, filed on Dec. 08, 2005, and 10-2006-0031486, filed on Apr. 06, 2006, in the Korean Intellectual Property Office, the disclosure of which is incorporated herein in its entirety by reference.

### BACKGROUND OF THE INVENTION

1. Field of the Invention

The present invention relates to a method and apparatus for blocking an attack against a Web-application, and more particularly, to an apparatus which is disposed between a Web service request client and a Web server and blocks an attack using Web service request data, and a method therefor.

2. Description of the Related Art

A Gartner Group's report indicates that an application layer performs 75% of Web application attacks. The computer emergency response team (CERT) announces that Web hacking occupies about 70 percent of whole hackings and that an attack against a Web application is serious.

The attack against the Web application frequently occurs when a Web application program code does not properly filter a user input value, and modifies Web service request data in various forms. Therefore, a system for blocking the attack against the Web application must be developed in order to effectively avoid modifiable attacks against the Web application.

### SUMMARY OF THE INVENTION

The present invention provides an apparatus and method for blocking a modified attack against a Web application in real time.

According to an aspect of the present invention, there is provided a An apparatus for blocking an attack against a Web application, the apparatus comprising: an input value authentication unit authenticating an input value included in Web service request data and determining the attack; an input value filtering unit editing Web service request data determined as the attack by removing an attack element from the Web service request data; and a data transfer unit transferring Web service request data which is not determined as the attack and the edited Web service request data to a Web server.

According to another aspect of the present invention, there is provided a method of blocking an attack against a Web application, the method comprising: (a) authenticating an input value included in Web service request data and determining the attack; (b) editing Web service request data determined as the attack by removing an attack element from the Web service request data; and (c) transferring Web service request data which is not determined as the attack and the edited Web service request data to a Web server.

### BRIEF DESCRIPTION OF THE DRAWINGS

The above and other features and advantages of the present invention will become more apparent by describing in detail exemplary embodiments thereof with reference to the attached drawings in which:

FIG. 1 is a diagram for explaining an apparatus for blocking an attack against a Web application according to an embodiment of the present invention;

FIG. 2 is a block diagram of an apparatus for blocking an attack against a Web application according to an embodiment of the present invention: and

FIG. 3 is a flowchart of a method of blocking an attack against a Web application according to an embodiment of the present invention.

### DETAILED DESCRIPTION OF THE INVENTION

The filtering method and apparatus according to the present invention will now be described more fully with reference to the accompanying drawings, in which exemplary embodiments of the invention are shown.

Main defects of a Web application will now be described.

First, an input value parameter is not authenticated. When a client requests a Web application, if it is not authenticated whether the request of the client is a proper value, an unauthorized resource in a backend can be accessed. Security mechanism can be bypassed by forcibly browsing HTTP requests such as a URL, a query text, a HTTP header, a form field, a cookie, a hidden filed, etc., or inserting a command language, forging/modifying cookies, etc.

Second, cross-site scripting occurs due to modifications made when the Web application permits a JAVA script text, HTML tags into a user's input value.

Third, an SQL injection occurs when the Web application requests a query for database. When special characters such as—(space), %, etc. which are not allowed by SQL are included in the user's input value, an error is not processed, which fails to filter offensive content of the query.

Fourth, IDS can be bypassed by using a Hexar code, a Unicode, and a Windows %u code in a URL field for an attack against the Web application.

The attack against the Web application frequently occurs when a Web application program codes doe not properly filter the user's input value, and can modify Web service request data in a variety of forms. However, conventional signature-based security solution cannot effectively defend the attack against the Web application. A firewall must allow an access to a TCP 80 port to properly provide a service of a Web server. An IPS can defend an attack having a regular signature pattern since the IPS is analysed in a packet which is the smallest communication unit.

To most effectively prevent these defects of the Web application, it is necessary to authenticate all parameters such as the header, the cookie, the query text, the form field, the hidden filed, etc. under strict allowable regulations and convert them into normal equations.

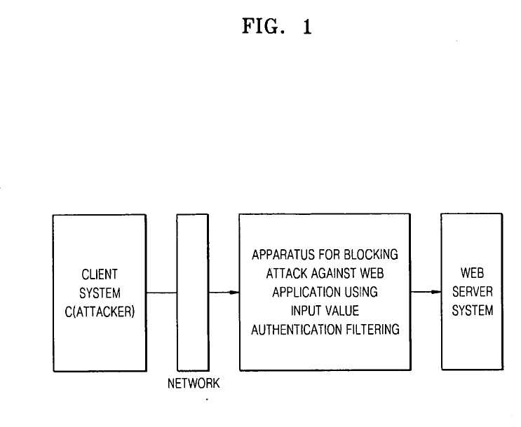

FIG. 1 is a diagram for explaining an apparatus for blocking an attack against a Web application according to an embodiment of the present invention. Referring to FIG. 1, the apparatus for blocking the attack against the Web application is disposed between a Web service request client and a Web server, hijacks a web service request data from the client system, authenticates an input parameter value used to perform the attack against the Web application included in the web service request data, and the web service request data determined as the attack by removing an attack element from the web request service data, and transfers the filtered web service request data to the web server system.

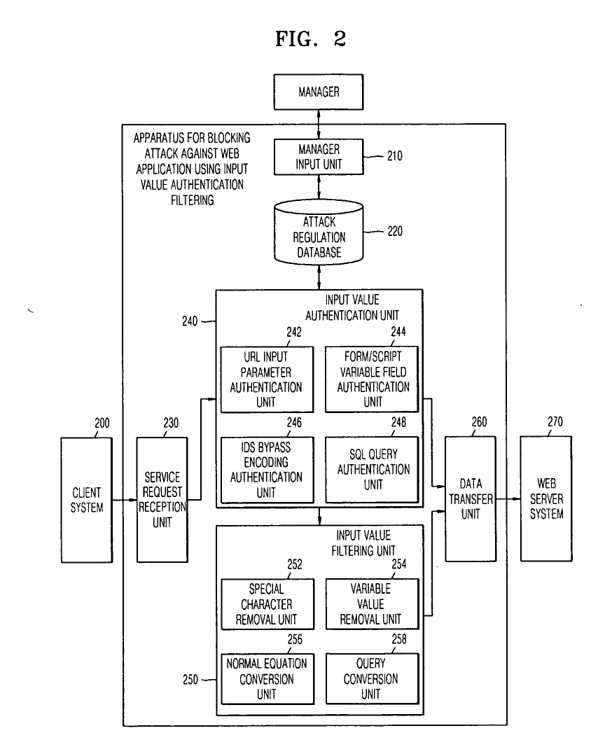

FIG. 2 is a block diagram of an apparatus for blocking an attack against a Web application according to an embodiment of the present invention. Referring to FIG. 2, the apparatus for blocking the attack against the Web application comprises a client system 200, a manager input unit 210, an attack regulation database 220, a service request reception unit 230, an input value authentication unit 240, an input value filtering unit 250, a data transfer unit 260, and a Web server system 270.

The client system 200 transmits Web service request data.

The manager input unit 210 receives Web application attack pattern regulations from a manager and transfers it to the attack regulation database 220.

The attack regulation database 220 stores the received Web application attack pattern regulations such as an SQL query data format (characters, fixed numbers, real numbers, etc.), allowable character sets (special characters), minimum/maximum allowable length, whether a NULL value is allowed, whether a parameter is allowed, an allowable number range, a normal equation, etc., which are determined as the attack against the Web application.

The service request reception unit 230 receives Web service request data transmitted from the client system 200.

The input value authentication unit 240 authenticates input values included in the Web service request data received by the service request reception unit 230 and determines whether the Web service request data is the attack against the Web application. In detail, the input value authentication unit 240 authenticates user input values by checking an URL input parameter, a form/script variable value, IDS bypass encoding, SQL query, etc. with respect to the Web service request data through a URL, a query text, a HTTP header, a form/script field, a cookie and hidden field, etc. The input value authentication unit 240 determines whether the Web service request data includes an attack element based on the attack pattern regulations stored in the attack regulation database 220. However, if the input value authentication unit 240 stores the attack regulations, the attack regulation database 220 can be omitted. If the input values authenticated by the input value authentication unit 240 are identical to the Web application attack pattern regulations, the Web service request data is determined as the attack against the Web application, and is transferred to the input value filtering unit 250. If it is determined that the Web service request data is not the attack against the Web application, the Web service request data is transferred to the data transfer unit 260.

The input value authentication unit 240 can comprise a URL input parameter authentication unit 242, a form/script variable field authentication unit 244, an IDS bypass encoding authentication unit 246, and a SQL query authentication unit 248.

If the URL input parameter authentication unit 242 detects an erroneous URL input parameter value, the Web service request data is determined as the attack against the Web application. An example of the erroneous URL input parameter is a “//////////” request, which is a pattern for exploiting an Apatch bug.

The form/script variable field authentication unit 244 authenticates a form/script variable value (POST, GET, <script>, $ variable). In detail, if the form/script variable field authentication unit 244 detects a form/script variable value used to attack a cross-site script, the Web service request data is determined as the attack against the Web application. An example of the form/script variable value is a “( and )” request, which is a pattern used to attack the cross-site script.

If the IDS bypass encoding authentication unit 246 detects a modified coding value for the IDS bypass, the Web service request data is determined as the attack against the Web application. An example of the modified coding value for the IDS bypass is a bypass using a Hexar code,
http://xxx/script.ext?template=%2e%2e%2f%2e%2e%2f%65%74%63%2f%70%61%73%73%77%64, which indicates http://xxx/script.ext?template=../../etc/passwd.

If the SQL query authentication unit 248 detects an unallowable character relating to SQL, the Web service request data is determined as the attack against the Web application. For example, a “'” request is a pattern attempting to attack the SQL injection.

The input value filtering unit 250 edits the Web service request data determined as the attack against the Web application to remove the attack element from the Web service request data, and provides the edited Web service request data to the data transfer unit 260. In detail, the input value filtering unit 250 removes unallowable special characters (*, <, +, ///, etc.) used in the attack pattern, authenticates all parameters such as a header, a cookie, a query text, a form field, a hidden field, etc. and converts input data of a left field into input data of a right field (<=&lt; >=&gt;, (=$#40; )=&#35), or processes errors when the user input values include SQL related special characters such as; , −(space) %, converts a Hexar code attack pattern into the normal equation, and deletes, converts, and filters the Web service request input values. The input value filtering unit 250 can provide the manager with a detection result and a reporting function with regard to a filtered Web application attack.

The input value filtering unit 250 comprises a special character removal unit 252, a variable value removal unit 254, a normal equation conversion unit 256, and a query conversion unit 258.

The special character removal unit 252 removes an input parameter value that uses an unallowable special character included in the Web service request data determined as the attack against the Web application. Examples of the unallowable special character used in the attack pattern are *, <, +, ///.

The variable value removal unit 254 removes a JAVA script text used to attack the cross-site scripting included in the Web service request data determined as the attack against the Web application. For example, the Hexar code attack pattern is converted into the normal equation.

The query conversion unit 258 removes the unallowable special character relating to SQL included in the Web service request data determined as the attack against the Web application. For example, if the user input values include the SQL related special characters such as ‘ ’;, −(space) %, the query conversion unit 258 removes the SQL related special characters.

The input value filtering unit 250 edits the Web service request data as described below. If the input value filtering unit 250 receives
http://xxx.xxx.xxx.xxx/../../../..///////////////////////////////////////” it outputs “http://xxx.xxx.xxx.xxx/”. If the input value filtering unit 250 receives http://xxx.xxx.xxx.xxx
/index.php?stupid=<img%20src=javascript:alert(document.domain)> “it outputs “http://xxx.xxx.xxx/index.php?stupid==<img%20src=>”. If the input value filtering unit 250 receives http://xxx/
script.ext?template=%2e%2e%2f%2e%2e%2f%65%74%63%2f%70% 61%73%73%77%64“ it outputs “http://xxx/script.ext?template=”.

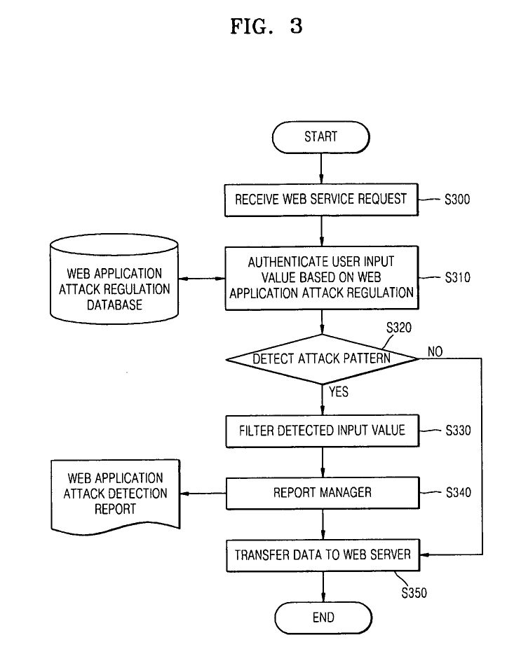

FIG. 3 is a flowchart of a method of blocking an attack against a Web application according to an embodiment of the present invention. Referring to FIG. 3, the service request reception unit 230 receives Web service request data (Operation 300). Before Operation 300, the attack regulation database 220 can store Web application attack pattern regulations through the manager input unit 210.

The input value authentication unit 240 authenticates input values included in the Web service request data (Operation 310), and determines whether the Web service request data is the attack against the Web application according to the authentication (Operation 320). If it is determined that the Web service request data is not the attack against the Web application, the input value authentication unit 240 transfers the Web service request data to the data transfer unit 260. If it is determined that the Web service request data is the attack against the Web application, the input value authentication unit 240 transfers the Web service request data to the input value filtering unit 250.

The input value filtering unit 250 removes an attack element from the Web service request data determined as the attack against the Web application (Operation 330). The input value filtering unit 250 can report a filtering result to a manager (Operation 340).

The data transfer unit 260 transfers the edited Web service request data or the Web service request data which is not determined as the attack against Web application to the Web server system 270 (Operation 350).

The present invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, and optical data storage devices. The computer readable recording medium can also be distributed network coupled computer systems so that the computer readable code is stored and executed in a distributed fashion. Also, functional programs, codes and code segments for accomplishing the present invention can be easily construed by programmer skilled in the art to which the present invention pertains.

According to the present invention, an input value authentication filtering method is used to avoid a modified attack against a Web application in real time. Also, unlike a conventional Web application security system that blocks a packet against Web hacking, an attack against the Web application is converted into a normal pattern, thereby reducing an attacker's desire for hacking.

While the present invention has been particularly shown and described with reference to exemplary embodiments thereof, it will be understood by those of ordinary skill in the art that various changes in form and details may be made therein without departing from the spirit and scope of the present invention as defined by the following claims. The preferred embodiments should be considered in a descriptive sense only and not for purposes of limitation. Therefore, the scope of the invention is defined not by the detailed description of the invention but by the appended claims, and all differences within the scope will be construed as being included in the present invention.

What is claimed is:

1. An apparatus for blocking an attack against a Web application, the apparatus comprising:
an input value authentication unit authenticating an input value included in Web service request data and determining the attack;
an input value filtering unit editing Web service request data determined as the attack by removing an attack element from the Web service request data; and
a data transfer unit transferring Web service request data which is not determined as the attack and the edited Web service request data to a Web server.

2. The apparatus of claim 1, wherein the input value authentication unit performs at least one of a URL input parameter check, a form/script variable value check, an IDS bypass encoding check, and a SQL query check with respect to the Web service request data and authenticates the input value.

3. The apparatus of claim 1, wherein the input value authentication unit comprises:
a URL input parameter authentication unit detecting an erroneous URL input parameter value;
a form/script variable field authentication unit detecting a form/script variable value used to attack a cross-site script;
an IDS bypass encoding authentication unit detecting a modified coding value for IDS bypass; and
an SQL query authentication unit detecting an unallowable character relating to SQL.

4. The apparatus of claim 1, wherein the input value filtering unit removes the attack element by performing at least one of an unallowable special character removal, a variable value removal, a query conversion, and a normal equation conversion.

5. The apparatus of claim 1, wherein the input value filtering unit comprises:
an unallowable special character removal unit removing an input parameter value that uses an unallowable special character included in the Web service request data determined as the attack;
a variable value removal unit removing a JAVA script text used to attack the cross-site script included in the Web service request data determined as the attack;
a normal equation conversion unit converting a coding value used to encode IDS bypass included in the Web service request data determined as the attack; and
a query conversion unit removing an unallowable special character relating to SQL included in the Web service request data determined as the attack.

6. A method of blocking an attack against a Web application, the method comprising:
(a) authenticating an input value included in Web service request data and determining the attack;
(b) editing Web service request data determined as the attack by removing an attack element from the Web service request data; and
(c) transferring Web service request data which is not determined as the attack and the edited Web service request data to a Web server.

7. The method of claim 6, wherein in operation (a), at least one of a URL input parameter check, a form/script variable value check, an IDS bypass encoding check, and a SQL query check is performed with respect to the Web service request data and the input value is authenticated.

8. The method of claim 6, wherein the input value authentication unit comprises:
detecting an erroneous URL input parameter value;
detecting a form/script variable value used to attack a cross-site script;
detecting a modified coding value for IDS bypass; and
detecting an unallowable character relating to SQL.

9. The method of claim 6, wherein in operation (b), the attack element is removed by performing at least one of an unallowable special character removal, a variable value removal, a query conversion, and a normal equation conversion.

10. The method of claim 6, wherein operation (b) comprises:
removing an input parameter value that uses an unallowable special character included in the Web service request data determined as the attack;
removing a JAVA script text used to attack the cross-site script included in the Web service request data determined as the attack;
converting a coding value used to encode IDS bypass included in the Web service request data determined as the attack; and
removing an unallowable special character relating to SQL included in the Web service request data determined as the attack.

11. A computer readable recording medium having embodied thereon a computer program for executing a method of claim 6.
